(19) United States
(12) Patent Application Publication
(10) Pub. No.: US 2008/0263264 A1
(43) Pub. Date: Oct. 23, 2008

(54) DATA ACCESS CONTROL SYSTEM AND METHOD OF MEMORY DEVICE

(75) Inventors: Wen-Hsuan Lin, Taipei County (TW); Kuo-Wei Huang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/762,083

(22) Filed: Jun. 13, 2007

(30) Foreign Application Priority Data
Apr. 17, 2007 (TW) 96113439

(51) Int. Cl. G06F 12/00

(52) U.S. Cl. 711/103

(57) ABSTRACT

A data access control system of a memory includes a micro-processor, having a micro-controller, a command decoder, and a memory interface. The data access control system can be used to control display driving of a display system. The command decoder is used to decode the content of a data access command. A memory unit is configured into a first region for storing a first-type data being stored in a memory manner, and a second region for storing a second-type data being stored in a simulation manner of the memory. A bus is connected between the micro-processor and the memory unit, for performing data transmission. The micro-processor uses the memory interface to write data into the first region of the memory unit, and uses the command decoder to convert the nonvolatile data and write into the second region of the memory unit.

### CROSS-REFERENCE TO RELATED APPLICATION

This application claims the priority benefit of Taiwan application serial no. 96113439, filed Apr. 17, 2007. All disclosure of the Taiwan application is incorporated herein by reference.

### BACKGROUND OF THE INVENTION

1. Field of the Invention

The present invention relates to a memory access technology. More particularly, the present invention relates to a data access control system of a memory, capable of accessing at least two different types of data.

2. Description of Related Art

In a conventional display system, it is necessary to save the adjustment information of the user, so as to return to the status before shutdown after the next booting, so the display system needs a memory apparatus capable of reading and writing at any moment. In addition to the adjustment information of the user, it is necessary to save other information of the display system, for example, automatically adjusting parameters such as EDID, HDCP, and color information, as well as other kinds of self-defined information. In a conventional display system, a relatively popular memory apparatus used to store such information is the electrically erasable programmable read only memory (EEPROM). In this kind of memory, any position of the memory can be read and written randomly, and various storing data can be stored and updated easily. However, the display system still requires a memory storage apparatus, i.e., the flash memory, to serve as the program memory of the micro-processor. Therefore, usually the conventional display apparatus needs the above two memory apparatuses, resulting in the increase of the cost and the system complexity.

FIG. 1 is a schematic view of the mechanism that the micro-processor accesses the data for controlling in the conventional display system. Referring to FIG. 1, the micro-processor 100 includes a micro-control unit 100a and a flash memory interface 100b. The micro-processor 100 is connected to a nonvolatile memory 102 and a flash memory 106 by different types of buses, so as to access different types of data. Usually, the nonvolatile memory 102 is an EEPROM, and is connected to the micro-control unit 100a by an inter integrated circuit (IIC) bus 104, so as to transmit the data. However, usually the control program used by the micro-control unit 100a is stored in the flash memory 106, and is also called the program memory. Therefore, the micro-control unit 100a uses the bus 108 to transmit the address and data, so as to access the flash memory 106.

Based on the above conventional operating manner, different types of data must be respectively stored in different types of memories, and different buses are used to transmit the data. Thus, the conventional memory data access system, especially the arrangement of controlling the data access of the memory of the display apparatus, results in the increase of the cost and the system complexity.

### SUMMARY OF THE INVENTION

Accordingly, the present invention is directed to providing a data access control system of a memory and a method thereof. The control mechanism is used to share a program memory, i.e., a flash memory, used by a micro-controller in a display system, so as to store and update the data of various display apparatuses. According to this method, the EEPROM in the display system can be omitted, the cost and the complexity of the system can be reduced, and the access time to an external memory can be shortened as well.

The present invention provides a data access control system of a memory, which includes a micro-processor having a micro-controller, a command decoder, and a memory interface. The data access control system is used to control display driving of a display system. The command decoder is used to decode the content of a data access command. A memory unit is configured into a first region storing a first-type data stored in a memory manner and a second region storing a second-type data stored in a simulation manner of the memory. A bus is connected between the micro-processor and the memory unit, so as to perform data transmission. The micro-processor uses the memory interface to write the data into the first region of the memory unit, and uses the command decoder to convert the nonvolatile data and to write into the second region of the memory unit.

In the data access control system of the memory according to a preferred embodiment of the present invention, for example the bus includes a parallel bus or a serial bus.

In the data access control system of the memory according to a preferred embodiment of the present invention, for example the first region of the memory unit stores a control program data required by the micro-controller. Further, the memory for example includes a flash memory unit.

In the data access control system of the memory according to a preferred embodiment of the present invention, for example the second-type data includes the data of EEPROM.

In the data access control system of the memory according to a preferred embodiment of the present invention, for example the command decoder of the micro-processor converts the second-type data transmitted by an IIC bus to a format compatible with the bus, so as to store the second-type data to the second region.

In the data access control system of the memory according to a preferred embodiment of the present invention, for example the command decoder is coupled to a timing controller, and the timing controller provides the decoding with a data block as an accessing unit.

In the data access control system of the memory according to a preferred embodiment of the present invention, for example a buffer unit coupled to the memory interface is further included, so as to register a part of transmitted data.

In the data access control system of the memory according to a preferred embodiment of the present invention, for example the micro-processor is disposed in a display apparatus, so as to control the image display.

The present invention provides a data access control method of the memory, for allowing a micro-control unit to access the data of a memory. The method includes configuring the memory into a first data region and a second data region. The micro-control unit sends a data writing command to write an access data. A data access command is decoded by a command decoder, so as to know whether the access data is a first format data or a second format data. If the access data is the first format data, the access data is stored in the first region of the memory. If the access data is the second format data, the access data is converted to a data transmission format same as the first format data, and the access data is stored in the second region of the memory.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of the mechanism that the micro-processor accesses the data for controlling in the conventional display system.

FIG. 2 is a schematic block view of the data access control system of a memory according to an embodiment of the present invention.

FIG. 3 is a schematic view of the flow of the mechanism of the data access control method of a memory according to an embodiment of the present invention.

FIG. 4 is a schematic view of the flow of the mechanism of the data access control method of a memory according to another embodiment of the present invention.

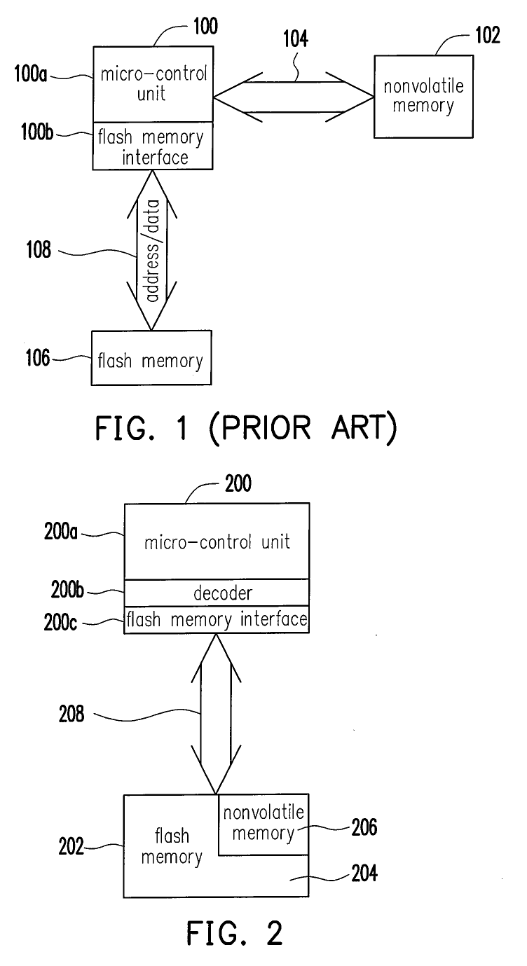

### DESCRIPTION OF EMBODIMENTS

The present invention provides a control mechanism to share the program memory used by the micro-controller in the display system, and to store the necessary information required by the display apparatus. In this manner, the cost and the complexity of the system are reduced, and the access time to the external memory is reduced. The following embodiments are used to illustrate the detailed implementation and the inventive spirit of the present invention, and are not used to limit the scope of the present invention.

FIG. 2 is a schematic block view of the data access control system of a memory according to an embodiment of the present invention. Referring to FIG. 2, the data access control system of a memory of the present invention includes a micro-processor 200 and a memory unit 202, and a bus 208 is used to transmit the data, which can also include address and data content. The bus 208 can be a parallel bus or a serial bus.

The micro-processor 200 for example includes a micro-control unit 200a, a decoder 200b, and a memory interface 200c. The decoder 200b is for example a command decoder for decoding the content of a data access command. The memory interface 200c is for example a nonvolatile memory interface or a flash memory interface. The data access control system of the present invention can also be used to control display driving of a display system.

Further, corresponding to the access operation of the micro-processor 200, a memory unit 202, for example a nonvolatile memory, is configured into a first region (204) for storing a first-type data stored in a memory manner, and a second region (206) for storing a second-type data stored in a simulation manner of the memory. In this embodiment, taking the flash memory as an example, the first region is for example the flash memory 204 that accesses the data in the original storing manner. Particularly, for example when it is needed to write the data, the data transmission is performed between the micro-processor 200 and the memory unit 202 through the bus 208. That is, the micro-processor 200 uses the memory interface 200c to write the data into the first region 204 of the memory unit 202.

However, in order to enable the micro-processor 200 to write different types of data, for example other nonvolatile data transmitted in an IIC bus manner, into the flash memory unit 202, the micro-processor 200 uses the command decoder 200b to convert the nonvolatile data to the access manner of the flash memory and to write into the second region (206) of the memory unit 202. In this embodiment, the second region (206) uses the flash memory to simulate the region of the nonvolatile memory 206. Therefore, the present invention can omit the IIC bus for accessing the data of the EEPROM in the conventional art.

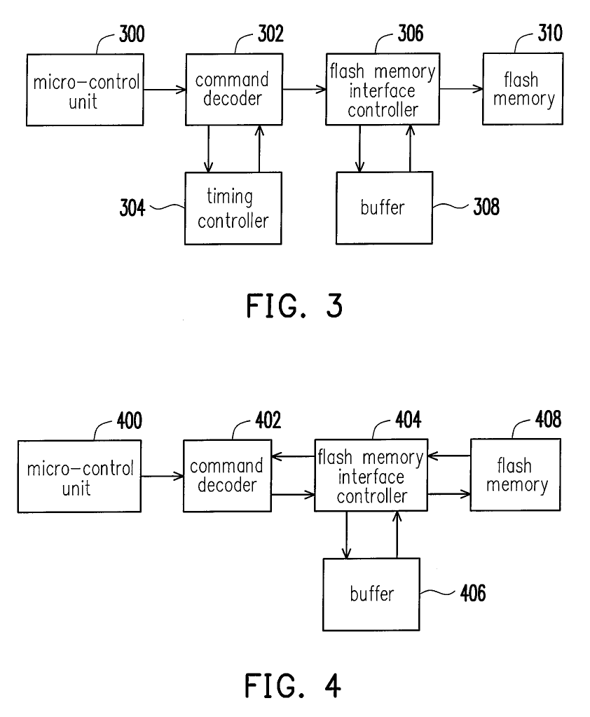

Next, FIG. 3 is a schematic view of the flow of the mechanism of the data access control method of a memory, according to an embodiment of the present invention. Referring to FIG. 3, with the system architecture of FIG. 2, the data access control method is mainly performed by four control units. The micro-processor 300 uses the command decoder 302 and the flash memory interface controller 306 to write the data into the flash memory 310. Further, a timing controller 304 is coupled to the command decoder 302, for providing the timing of decoding. At this time, the data is delivered with a data block as the unit, so the timing controller is used to properly decode the content of the command. Definitely, different commands have different contents and actions. Further, for example, usually the data to be written is firstly stored in a buffer, for example a Static Random Access Memory (SRAM).

For the application of the display apparatus, the control method is mainly that the micro-controller 300 sends an execution order according to the program of a display application system. The internal control mechanism executes different actions according to the orders, and the orders are defined according to the commands usually used by normal memories. The commands for example include:

Write enable: execute the order before executing the write order;

WSR (Write Status Register)/RDSR (Read Status Register): access the status of the memory to the register;

Sector Erase & Block Erase: erase the block of the memory; and

Program & Page Program: write the updated data.

The above commands can certainly have different command definitions corresponding to different applications and requirements.

The stored display apparatus information cannot be altered in any abnormal condition, so it is necessary to avoid executing the commands under the abnormal condition. Therefore, the micro-processor 300 uses a special continuous read and write action as the command. Each command is differentiated by the individually represented continuous read and write action. The command decoder 302 monitors whether each read and write action is the command or the usual program action at any moment. When the command is decoded to be any command, the relative mechanism is activated. The executing time of each command is different, and the specification of each flash memory is different, so the command decoder 302 transmits the decoded command information to the timing controller 304. The timing controller 304 generates an interrupt for executing “command executing end” according to different commands and different memory settings, such that the control mechanism knows the current command execution and memory status.

The command decoder 302 also transmits the decoded command information to the memory controller, for example the flash memory interface controller 306, which mainly generates the control signal of the flash memory, so as to convert the command to a control signal. Different commands are decoded into different required information. For example, the erasing block command includes erasing the address of the block. The writing command includes writing the address and the data, and the block writing command includes the block writing address, the length, and the address of the data to be written in the buffer 308. For the block writing command, the memory control unit activates an internal direct memory access (DMA) mechanism to automatically and continuously read out the data from the buffer 308, and to convert into the flash memory, till the block writing length is achieved. Before executing the erasing and the writing commands, the RDSR command is automatically executed to ensure that the current status of the memory is the accessible status.

Further, if the data is delivered in a manner of byte, some differences exist. FIG. 4 is a schematic view of the flow of the mechanism of the data access control method of a memory according to another embodiment of the present invention. Referring to FIG. 4, the difference to FIG. 3 is that the timing controller is not required. The mechanism is mainly that many memories have flags indicating whether the action is finished or not. In FIGS. 3 and 4, the micro-control unit 400 can send the commands. When the command decoder 402 decodes any command, relative mechanism is activated, and the decoded command information is delivered to the memory control unit 404, for example the flash memory interface controller. The memory control unit 404 generates control signals of the flash memory according to different commands. After executing the erasing or the writing command, the memory control unit 404 will activate an automatic detection mechanism, so as to continuously send the RDSR command to know the current status of the memory. Once the information status read from the memory 408 is finished, an interrupt signal is send to the command decoder 402 to make it know that the command is finished, and the next command execution can be accepted. The operation between the memory control unit 404 and the buffer 406 is same as FIG. 3, and the data can be for example firstly written into the buffer 406, and then written into the memory 408. However, it is understood that the buffer 406 is not an absolutely necessary unit.

To sum up, the control mechanism of the present invention can at least allow a display apparatus applying it to require a nonvolatile memory only, for example the flash memory, which not only stores the program code of the micro-processor, but also stores the necessary information required by the display apparatus. Moreover, the correctness and the execution of the program code will not be affected, and the stored display information can be updated at any moment. Thus, the cost and the system complexity of the display apparatus are reduced, and the access time to the external memory is reduced.

Although the present invention can be applied in the display apparatus as a part to control the display, the present invention is not limited to the application. Supported by the decoder and the controller, the present invention can simulate and configure two different types of storage regions on a same memory to store different types of data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data access control system of a memory, comprising:
a micro-processor, comprising a micro-controller, a command decoder, and a memory interface, wherein the command decoder is used to decode a content of a data access command;
a memory unit, comprising a first region and a second region, wherein the first region is used to store a first-type data of a first format, the second region is used to store a second-type data, and the second-type data is stored in the second region in a simulation manner of the first format; and
a bus, connected between the micro-processor and the memory unit, so as to perform data transmission;
wherein the micro-processor uses the memory interface to write the first-type data into the first region of the memory unit, and uses the command decoder to simulative and convert the second-type data to the first format and to write into the second region is of the memory unit.

2. The data access control system of a memory as claimed in claim 1, wherein the bus comprises a parallel bus or a serial bus.

3. The data access control system of a memory as claimed in claim 1, wherein the first region of the memory unit stores a control program data used by the micro-controller.

4. The data access control system of a memory as claimed in claim 1, wherein the memory unit comprises a flash memory unit.

5. The data access control system of a memory as claimed in claim 1, wherein the second-type data comprises the data of an electrically erasable programmable read only memory (EEPROM).

6. The data access control system of the memory as claimed in claim 1, wherein the command decoder of the micro-processor converts the second-type data transmitted by an inter integrated circuit (IIC) bus to a format compatible with the bus, so as to store the second-type data to the second region.

7. The data access control system of the memory as claimed in claim 1, wherein the command decoder is coupled to a timing controller, and the timing controller provides decoding with a data block as an accessing unit.

8. The data access control system of a memory as claimed in claim 1, further comprising a buffer unit coupled to the memory interface, so as to register a part of transmission data.

9. The data access control system of a memory as claimed in claim 1, wherein the micro-processor is disposed in a display apparatus, so as to control image display.

10. A data access control method of a memory, for allowing a micro-control unit to access data of a memory, comprising:
configuring the memory into a first data region and a second data region;
the micro-control unit sending a data writing command, so as to write an access data;
decoding the data access command with a command decoder, so as to know whether the access data is a first format data or a second format data;
storing the access data to the first region in the memory if the access data is the first format data; and
converting the access data to a data transmission format compatible with the first format data and storing the access data in the second region of the memory if the access data is the second format data.

11. The data access control method of a memory as claimed in claim 10, further comprising firstly storing the access data in a buffer, and then storing the access data in the memory.

12. The data access control method of a memory as claimed in claim 10, wherein the data writing command sent by the micro-control unit uses a data block as a unit, and uses a timing controller to assist the decoding.

13. The data access control method of a memory as claimed in claim 10, wherein the data writing command sent by the micro-control unit uses a serial data to determine whether the data writing command is finished by detecting a status of the memory.

14. The data access control method of a memory as claimed in claim 10, wherein the first format data is a flash memory type.

15. The data access control method of a memory as claimed in claim 10, wherein the second format data is a nonvolatile memory type.

16. The data access control method of a memory as claimed in claim 15, wherein the second format data is a data type transmitted by an IIC bus.

17. The data access control method of a memory as claimed in claim 15, wherein the second format data comprises EEPROM.
